(19) United States
(12) Patent Application Publication
(10) Pub. No.: US 2005/0005783 A1
(43) Pub. Date: Jan. 13, 2005

(54) Device for cutting vegetables into ribbons or into strips including housing therefor

(75) Inventor: Herve De Buyer, Le Val d'Ajol (FR)

Correspondence Address: DRINKER BIDDLE & REATH, ONE LOGAN SQUARE, 18TH AND CHERRY STREETS, PHILADELPHIA, PA, 19103-6996, US

(73) Assignee: De Buyer Groupe

(21) Appl. No.: 10/824,878

(22) Filed: Apr. 15, 2004

(30) Foreign Application Priority Data
Apr. 16, 2003 (FR) 03 04 743

(51) Int. Cl. A23N 1/00

(52) U.S. Cl. 99/537

(57) ABSTRACT

A device for cutting vegetables into ribbons or into strips, comprising: a frame provided with at least one cutting blade mounted transversely relative to a slot for the passage of the cut vegetables as well as two lateral rails, and a housing guided for translation to and fro along the guide rails and defining in its interior a space for receiving vegetables to be cut.

The housing is constituted by a parallelepipedal guide chamber (1) which is open in its upper portion and has a length (L) substantially greater than its width (l), and by a pusher (2) comprising a presser plate forming a base (7) of a geometrical shape corresponding to the cross-section of the guide chamber (1) and fitting in that chamber (1), as well as by a grip (8) to be gripped manually by the user.

This application claims the benefit of French Patent Application No. 03 04 743, filed on Apr. 16, 2003, which is hereby incorporated by reference.

### FIELD OF THE INVENTION

The present invention relates to a device for cutting vegetables into ribbons or into strips or for cutting vegetables lengthwise, for both domestic and professional use, which device is distinguished from conventional models the cutting length of which is limited.

Within the scope of the invention, the word “vegetables” should be considered in a very broad sense and the vegetables which are cut may be not only vegetables strictly speaking, of any type, (potatoes, cucumbers, courgettes, carrots . . . ), but also fruit or other foods suitable for being cut lengthwise.

### SUMMARY OF THE INVENTION

There are currently on the market various types of manual vegetable cutters which have in common that they are not very practical and expose their users to serious risks of cuts to the hands.

There are also many electrical vegetable cutters or automatic machines of a multipurpose nature intended for household use or for industries or collectives.

However, as a general rule, these vegetable cutters or robots are sophisticated appliances which, in addition to their high cost, often have the disadvantage of being inconvenient to use and also difficult to clean.

To overcome this disadvantage, in accordance with the document FR-2 825 043, a simple, practical and inexpensive manual vegetable cutter has been proposed which enables the cutting characteristics to be varied selectively and moreover does not expose the user to serious risks of cuts to the hands.

This known device, which is known by experts as a “slicer” includes:
a frame provided with at least one cutting blade mounted transversely relative to a slot for the passage of the cut vegetables as well as two lateral rails, and
a housing guided for translation to and fro along the guide rails and defining in its interior a space for receiving vegetables to be cut.

The housing is intended to be gripped manually by the user in order to be moved to and fro along the guide rails whilst a pressure is constantly exerted on the vegetables contained in the receiving space so as to apply them against the cutting blade or blades mounted on the frame and to permit cutting by that blade or those blades.

This safety vegetable cutter has the advantage of enabling many different types of preparation to be performed without effort (smooth or corrugated disks, crinkle-cutting, dicing, . . . ) and has therefore been very well received by users.

It also has many other advantages which are connected, in particular, with the simplicity of the cutting-blade adjustment system which permits perfect cutting quality, with its compactness for storage, and also with its easy maintenance, particularly in a dishwasher.

However, this manual safety vegetable cutter does not enable vegetables to be cut lengthwise, that is, into ribbons or strips of quite considerable length.

Sliced vegetables similar in shape to lasagne or tagliatelle are currently much appreciated by consumers who have no other alternative but to produce them by hand.

The object of the present invention is to fill this gap.

For this purpose, the invention relates to a cutting device of the above-mentioned type, characterized in that the housing is constituted, on the one hand, by a parallelepipedal guide chamber which is open in its upper portion and has a length substantially greater than its width, the guide chamber being equipped with two lateral fins the edges of which are turned down in order to define two slides which have a substantially U-shaped cross-section and cooperate with the guide rails and, on the other hand, by a pusher comprising a presser plate forming a base of a geometrical shape corresponding to the cross-section of the guide chamber and fitting in that chamber in order to permit the application of the vegetables to be cut against the cutting blade or blades mounted on the frame during the movement of the housing, as well as by a grip to be gripped manually by the user so as to define an integral assembly during translation on the frame.

The frame of this cutting device is preferably similar to that described in the above-mentioned document FR-2 825 043 and may in particular comprise means for adjusting the cutting width so as to permit the production of lasagne-like sliced vegetables, particularly courgettes or carrots, of different thicknesses.

These means for adjusting the cutting width may in particular advantageously be constituted by a ramp translatable parallel to the cutting plane.

The cutting-width adjustment ramp can thus be kept constantly parallel to itself and the cutting width can consequently be adjusted whilst it is ensured that the first end of the ramp which faces the cutting blade or blades remains at a constant and very short distance from that blade or those blades.

A configuration of this type enables cutting to be optimised, on the one hand, by virtue of the small ramp/blade(s) clearance which ensures optimum uniformity and precision and, on the other hand, by virtue of the absence of variation in width during the translation of the vegetables towards the cutting blade or blades; this in fact prevents any phenomena of thinning-down at the end of the cut, which might be observed if the cutting-depth adjustment ramp were mounted so as not to be translatable parallel to the cutting plane but to be rotatable about a fixed axis of the frame by its second end remote from its first end which is situated facing the cutting blade or blades.

According to another preferred characteristic of the invention, the frame comprises at least one removable longitudinal chopper equipped with a set of equally-spaced blades directed substantially perpendicularly relative to the transverse blades so as to enable vegetables to be cut into tagliatelle-like strips or slices.

The frame may advantageously be equipped with a series of such choppers the blades of which have a greater or lesser spacing so as to produce strips of greater or lesser width.

The invention also relates to a housing intended for a device for cutting vegetables into ribbons or into strips of the above-mentioned type.

This housing in fact corresponds to an accessory suitable for a manual safety vegetable cutter as described in the document FR-2 825 043.

According to the invention, a housing of this type is characterized in that it is constituted, on the one hand, by a parallelepipedal guide chamber which is open in its upper portion and has a length substantially greater than its width and, on the other hand, by a pusher comprising a presser plate forming a base of a geometrical shape corresponding to the cross-section of the guide chamber and fitting in that chamber in order to permit the application of the vegetables to be cut against the cutting blade or blades mounted on the manual safety vegetable-cutter frame during the movement of the housing, as well as by a grip to be gripped manually by the user so as to define an integral assembly during translation on the frame.

It is essential that the guide chamber be narrow enough to prevent any pivoting of the vegetables to be cut during this translation.

According to the invention, the guide chamber is equipped with two lateral fins, the edges of which are turned down in order to define two slides having a substantially U-shaped cross section, for cooperating with the guide rails of the frame.

The presence of these slides corresponds to a particularly advantageous characteristic of the invention since it enables the housing and the frame to be rendered integral during the cutting process and thus enables the user's safety to be ensured whilst preventing any untimely separation of those elements.

According to the invention, the housing may be made of plastics material, of metal, or even of combined metal/plastics material so as to facilitate its manufacture and also its cleaning, particularly in a dishwasher.

The guide chamber preferably has a length of about 15 to 25 cm which enables very long vegetable slices to be produced.

According to another characteristic of the invention, the grip is constituted by an inverted U-shaped element substantially centred in the plane which is perpendicular to the presser plate forming the base and extends through the central longitudinal axis of that plate.

According to the invention, this element comprises, on the one hand, two lateral arms which are substantially perpendicular to the presser plate forming the base and the ends of which are fixed to that plate, respectively, at the level of its opposite edges which are intersected by the central longitudinal axis and, on the other hand, a central arm or gripping arm having an ergonomic shape.

According to the invention, the gripping arm of the grip may advantageously have cavities having a weight-reducing function.

The lateral arms of the grip may also themselves be equipped with stiffening plates if necessary.

According to another characteristic of the invention, the presser plate forming the base is equipped, on its lower face remote from the grip, with a series of spikes distributed uniformly over its surface and having the function of inserting themselves in the flesh of the vegetables to be cut, in order to hold them in position.

Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

### BRIEF DESCRIPTION OF THE DRAWING

The characteristics of the cutting device and of the housing which are the subject of the invention will be described in greater detail with reference to the appended non-limiting drawings in which:

FIG. 1 is an exploded perspective view of the housing,

FIG. 2 is a perspective view showing the lower face of the housing,

FIG. 3 is a perspective view of a variant of the pusher,

FIG. 4 is a perspective view showing the lower face of the pusher shown in FIG. 3, and

FIG. 5 is a perspective view of a second variant of the pusher.

### DETAILED DESCRIPTION OF THE PREFERRED EMBODIMENT

Reference will now be made in detail to the preferred embodiment of the present invention, example of which is illustrated in the accompanying drawings.

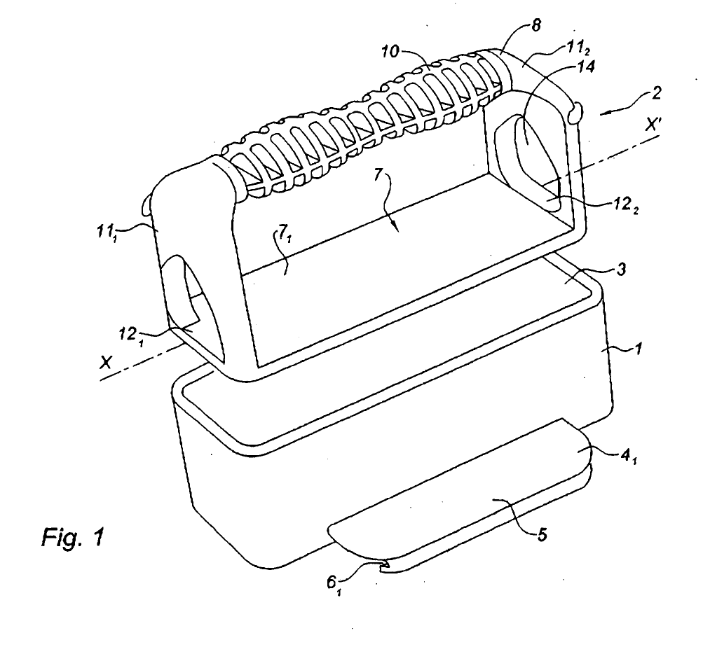

The housing shown in FIGS. 1 to 5 is intended to cooperate with a frame such as that described in the document FR-2 825 043.

For brevity, a frame of this type is not shown in the drawings.

According to FIG. 1, the housing is constituted by the combination of a guide chamber 1 and of a pusher 2.

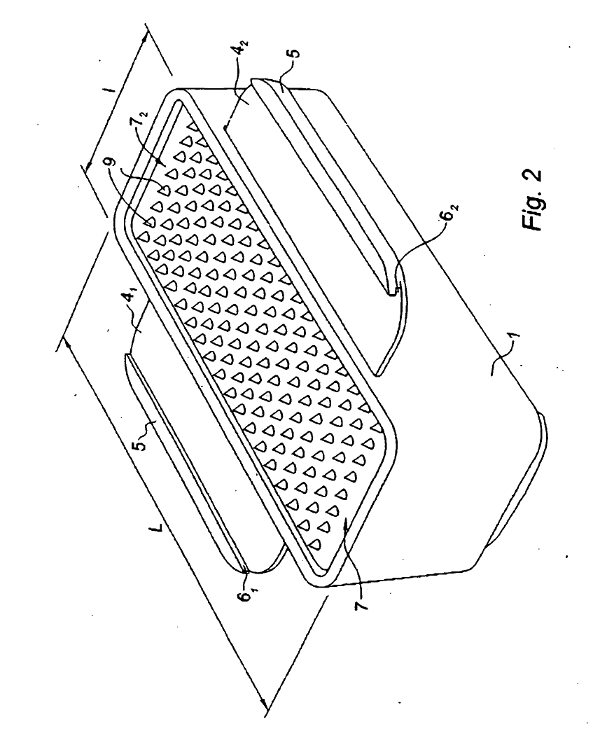

According to FIGS. 1 and 2, the guide chamber 1 is made of plastics material and is constituted by a substantially rectangular element which is open in its upper portion and in its lower portion and defines in its interior a space 3 for receiving vegetables to be cut.

According to FIG. 2, the length L of the guide chamber 1, which is of the order of from 15 to 20 cm, is substantially greater than its width l so as to prevent any pivoting of the vegetables to be cut after they have been put in place in the receiving space 3.

The guide chamber 1 is also equipped with two lateral fins 4₁, 4₂, the edges 5 of which are turned down so as to define two slides 6₁, 6₂ having a substantially U-shaped cross-section.

The slides 6₁, 6₂ are intended to cooperate with lateral rails with which the frame of the cutting device is equipped.

According to FIG. 1, the pusher 2 is constituted substantially by a presser plate forming a base 7 of rectangular shape the geometrical shape of which corresponds to the cross-section of the guide chamber 1, in which it fits as shown in FIG. 2.

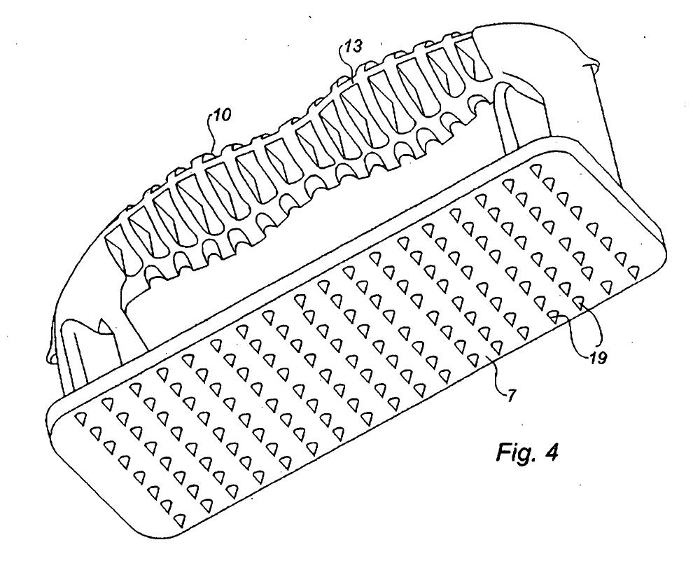

A first face 7₁ or upper face of the plate 7 is equipped with a grip 8, whereas the second face 7₂ or lower face of that plate 7 is equipped with a series of spikes 9 which are distributed uniformly over its surface and are shown in FIGS. 2 and 4.

According to FIG. 1, the grip 8 is constituted by an inverted U-shaped element made of plastics material substantially centred in the plane which is perpendicular to the presser plate forming the base 7 and extends through the central longitudinal axis X-X′ of that plate.

The element 8 comprises a central arm 10 or gripping arm of ergonomic shape as well as two lateral arms 11₁, 11₂ substantially perpendicular to the central arm 10 and situated on either side thereof.

The ends of the lateral arms 11₁, 11₂ are fixed to the presser plate forming the base 7 at the level of its opposite edges 12₁, 12₂ which are intersected by the central longitudinal axis X-X′.

According to FIGS. 1, 3 and 4, the gripping arm 10 of the grip 8 comprises cavities 13 in a parallel arrangement and having the function of reducing its weight.

According to the configuration shown by way of example in FIG. 1, the lateral arms 11₁, 11₂ of the grip 8 are constituted by plates extending over the entire width of the presser plate forming the base 7 and having cavities 14 in their central portion.

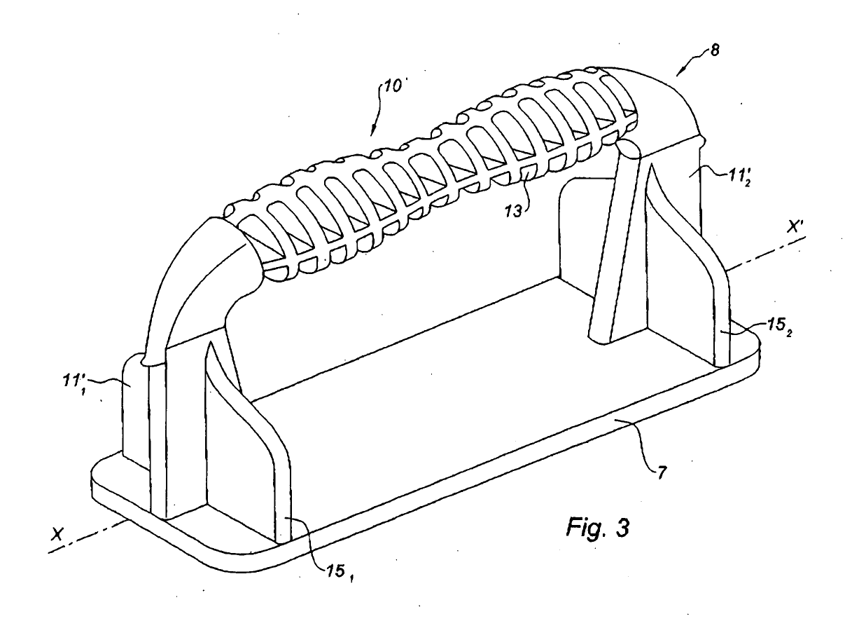

According to the variant shown in FIGS. 3 and 4, the lateral arms 11′₁, 11′₂ of the grip 8 extend substantially in the plane which is perpendicular to the presser plate forming the base 7 and extends through the central longitudinal axis X-X′ of that plate, and cooperate with lateral stiffening plates 15₁, 15₂ which are situated on either side of them.

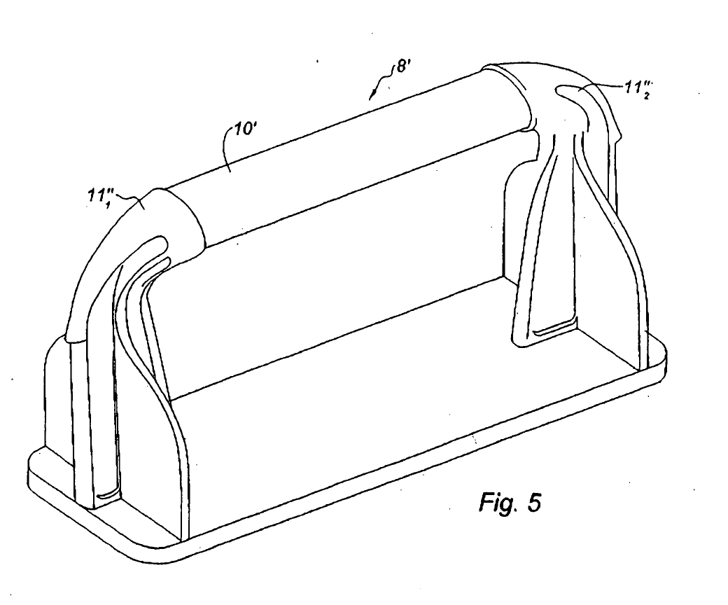

According to the second variant shown in FIG. 5, the grip 8′ is a dual-material grip and is constituted by the combination of a gripping arm 10′ made of metal and of lateral arms 11″₁, 11″₂ made of plastics material.

It should be noted that the grip, and even the guide-chamber/pusher assembly, could be entirely metallic without thereby falling outside the scope of the invention.

After the housing has been put in place on the guide rails with which the frame is equipped, the user can insert vegetables to be cut into ribbons or strips in the receiving space 3 of the guide chamber 1.

In order to cut the vegetables, the presser plate forming the base 7 must then be introduced into the receiving space 3 above the vegetables contained in that space and the grip 8 must then be gripped and the housing must be translated to and fro along the guide rails of the frame whilst a pressure is constantly exerted on the vegetables to be cut so as to apply them against the cutting blade or blades mounted on the frame and to enable them to be cut into ribbons or strips.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

1. Device for cutting vegetables into ribbons or into strips, comprising:
a frame provided with at least one cutting blade mounted transversely relative to a slot for the passage of the vegetables cut, as well as two lateral rails, and
a housing guided for translation to and fro along the guide rails and defining in its interior a space for receiving vegetables to be cut, the housing being intended to be gripped manually by the user in order to be moved to and fro along the guide rails whilst a pressure is constantly exerted on the vegetables contained in the receiving space so as to apply them against the cutting blade or blades mounted on the frame and to permit cutting by that blade or those blades,
characterized in that
the housing is constituted, on the one hand, by a parallelepipedal guide chamber which is open in its upper portion and has a length substantially greater than its width, the guide chamber being equipped with two lateral fins the edges of which are turned down in order to define two slides which have a U-shaped cross-section and cooperate with the guide rails and, on the other hand, by a pusher comprising a presser plate forming a base of a geometrical shape corresponding to the cross-section of the guide chamber and fitting in that chamber in order to permit the application of the vegetables to be cut against the cutting blade or blades mounted on the frame upon the movement of the housing, as well as by a grip to be gripped manually by the user so as to define an integral assembly during translation on the frame.

2. Device according to claim 1, characterized in that it comprises means for adjusting the cutting width.

3. Device according to claim 1, characterized in that it comprises at least one removable longitudinal chopper equipped with a set of equally-spaced blades directed substantially perpendicularly relative to the transverse blade or blades so as to enable the vegetables to be cut into strips.

4. Housing intended for a device for cutting vegetables into ribbons or into strips according to claim 1, characterized in that it is constituted, on the one hand, by a parallelepipedal guide chamber which is open in its upper portion and has a length substantially greater than its width, the guide chamber being equipped with two lateral fins the edges of which are turned down in order to define two slides having a substantially U-shaped cross-section and, on the other hand, by a pusher comprising a presser plate forming a base of a geometrical shape corresponding to the cross-section of the guide chamber and fitting in that chamber as well as a grip to be gripped manually by the user.

5. Housing according to claim 1, characterized in that the guide chamber has a length of about 15 to 20 cm.

6. Housing according to claim 1, characterized in that the grip is constituted by an inverted U-shaped element substantially centred in the plane which is perpendicular to the presser plate forming the base and extends through the central longitudinal axis of that plate and comprising, on the one hand, two lateral arms which are substantially perpendicular to the presser plate forming the base and the ends of which are fixed to that plate, respectively, at the level of its opposite edges which are intersected by the central longitudinal axis and, on the other hand, a central arm or gripping arm having an ergonomic shape.

7. Housing according to claim 6, characterized in that the central arm of the grip comprises cavities.

8. Housing according to claim 6, characterized in that the lateral arms of the grip are equipped with stiffening plates.

9. Housing according to 1, characterized in that the presser plate forming the base is equipped, on its lower face remote from the grip, with a series of spikes distributed uniformly over its surface.
